(19) United States
(12) Patent Application Publication
(10) Pub. No.: US 2025/0189380 A1
(43) Pub. Date: Jun. 12, 2025

(54) DEVICES FOR PREVENTING OXIDIZED VOLATILIZATION OF THERMOCOUPLE AT POOL BOTTOM

(71) Applicant: CAIHONG DISPLAY DEVICES CO., LTD., Xianyang (CN)

(72) Inventors: Longjiang ZHAO, Xianyang (CN); Wei YANG, Xianyang (CN); Jianbin LIU, Xianyang (CN); Jian XU, Xianyang (CN); Dacheng WANG, Xianyang (CN)

(73) Assignee: CAIHONG DISPLAY DEVICES CO., LTD., Xianyang (CN)

(21) Appl. No.: 18/969,212

(22) Filed: Dec. 4, 2024

Related U.S. Application Data
(63) Continuation of application No. PCT/CN2024/093138, filed on May 14, 2024.

(30) Foreign Application Priority Data
Dec. 6, 2023 (CN) 202311669323.5

(51) Int. Cl. G01K 1/08; G01K 7/04

(52) U.S. Cl. CPC G01K 1/08; G01K 7/04

(57) ABSTRACT

A device for preventing an oxidation and volatilization of a thermocouple at a pool bottom, including a junction box, a connection tube, a protection sleeve, a thermocouple core, and a protection tube. An insulating material is disposed between the connection tube and the protection sleeve, a high purity alumina slurry is sealingly filled between the protection tube and the thermocouple core. By disposing insulating material and the high purity alumina slurry at two ends of the thermocouple core, respectively, high temperature oxygen is prevented from entering and causing an oxidation and volatilization of the filament diameter and the sleeve that affects a measurement accuracy of the thermocouple, so as to provide direction and basis for the optimization and adjustment of the process.

### CROSS-REFERENCE TO RELATED APPLICATION

This application is a continuation of International Patent Application No. PCT/CN2024/093138, filed on May 14, 2024, which claims priority of Chinese Patent Application No. 202311669323.5 filed on Dec. 6, 2023, the contents of each of which are entirely incorporated herein by reference.

### TECHNICAL FIELD

The present disclosure relates to the field of temperature measurement technology of a thermocouple at the pool bottom of a high-generation substrate glass furnace, and in particular to a device for preventing an oxidation and volatilization of the thermocouple at the pool bottom.

### BACKGROUND

From a traditional color picture tube industry to a current panel display industry, glass is always a key component in display devices. Substrate glass is a framework and carrier of the entire display device, as well as an optical component. The substrate glass, as upper and lower substrates of the panel display device, needs to be processed by a fine microscopic semiconductor processing.

To achieve a great feeding volume, a high temperature flushing, and a long-term efficient and stable operation of a substrate glass furnace, a temperature measurement accuracy, and a long-term stability of a thermocouple at a pool bottom is a problem to be solved.

In a manufacturing process of the substrate glass, a glass batch is fed into a feeding port of the furnace through a feeding system in a stable and smooth manner, and then the glass batch is melted, clarified, and homogenized in the furnace to provide a qualified and homogeneous glass liquid for a next process. The glass liquid melted in the furnace is alkali-free, high-alumina borosilicate glass, and a glass product is mainly the substrate glass for the panel display.

The thermocouple at the pool bottom of the furnace bears a task of measuring a temperature of the glass liquid during a whole life cycle of the furnace, which is the main means to provide a favorable direction for a monitoring of a process adjustments. Once there is a significant attenuation on the measurement accuracy of the thermocouple, or the thermocouple fails, it causes a fatal blind spot in a process adjustment and optimization of the production line. Therefore, only by solving a high-temperature oxidation and volatilization problem of the thermocouple at the pool bottom, can the long-term efficient and stable operation of the thermocouple at the pool bottom be achieved in the furnace operation cycle, thereby providing a direction and basis for the optimization and adjustment of the process.

### SUMMARY

One or more embodiments of the present disclosure provide a device for preventing an oxidation and volatilization of a thermocouple at a pool bottom, including a junction box, a connection tube, a protection sleeve, a thermocouple core, and a protection tube. An insulating material is disposed between the connection tube and the protection sleeve, a gap sealing material is sealingly filled between the protection tube and the thermocouple core, one end of the protection tube is sleeved in the connection tube, and the other end of the protection tube is sleeved in the protection sleeve.

### BRIEF DESCRIPTION OF THE DRAWINGS

The present disclosure will be further illustrated by way of exemplary embodiments, which will be described in detail with reference to the accompanying drawings. These embodiments are not limiting, and in these embodiments, the same counting denotes the same structure, wherein:

FIG. 1 is a schematic diagram illustrating a structure of a device for preventing an oxidation and volatilization of a thermocouple at a pool bottom according to some embodiments of the present disclosure; and

FIG. 2 is a schematic diagram illustrating a partially enlarged view of part B in FIG. 1.

In the figures: 1, junction box; 2, connection tube; 3, protection sleeve; 4, gap sealing material; 5, thermocouple core; 6, insulating material; 7, protection tube.

### DETAILED DESCRIPTION

To present disclosure is described in further detail below in connection with specific embodiments, and what is described is an explanation and not a limitation of the present disclosure.

To enable those skilled in the art to better understand the embodiments of the present disclosure, the technical solutions in the embodiments of the present disclosure are clearly and completely described below in conjunction with the accompanying drawings, and it is clear that the described embodiments are only a part of the embodiments, not all of the embodiments. Based on the embodiments in the present disclosure, all other embodiments obtained by those skilled in the art without creative labor should fall within the scope of protection of the present disclosure.

It should be noted that the terms “first,” “second,” etc., in the present disclosure, the claims of the present disclosure, and the accompanying drawings described above are used to distinguish similar objects and not be used to describe a particular order or sequence. It should be understood that the data so used are interchangeable when appropriate, so that the embodiments of the present disclosure described herein are able to be practiced in an order other than those illustrated or described herein. Additionally, the terms “including” and “having,” and any variations thereof, are intended to cover non-exclusive embodiments. For example, a process, method, system, product, or apparatus that includes a series of operations or units are not limited to those that are clearly listed, but include other operations or units that are not clearly listed or inherent to the process, method, product, or apparatus.

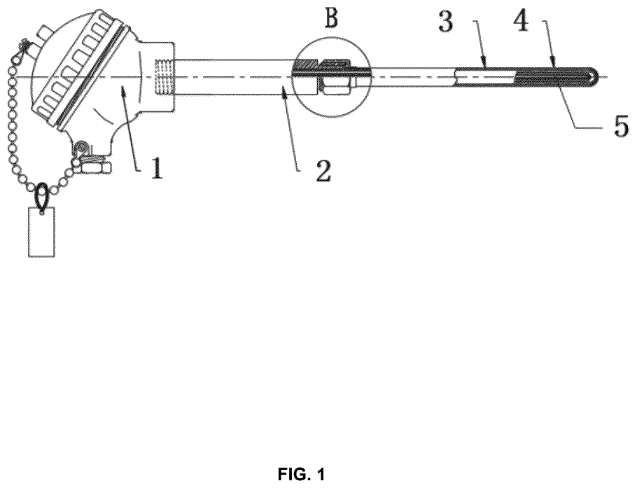

FIG. 1 is a schematic diagram illustrating a structure of a device for preventing an oxidation and volatilization of a thermocouple at a pool bottom according to some embodiments of the present disclosure.

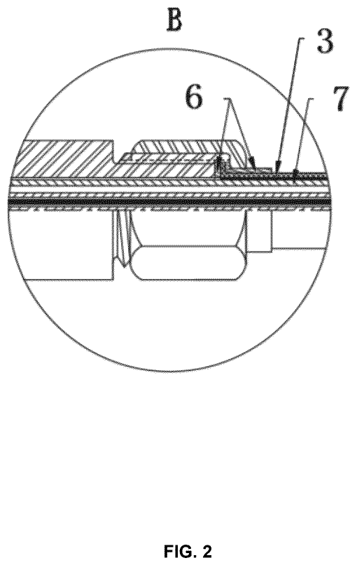

As shown in FIG. 1 and FIG. 2, embodiments of the present disclosure provide a device for preventing the oxidation and volatilization of a thermocouple at a pool bottom. The device includes a junction box 1, a connection tube 2, a protection sleeve 3, a thermocouple core 5, and a protection tube 7.

An insulating material 6 is disposed between the connection tube 2 and the protection sleeve 3, and a gap sealing material 4 is sealed and filled between the protection sleeve 3 and the thermocouple coupling core 5. One end of the protection tube 7 is sleeved in the connection tube 2, and the other end of the protection tube 7 is sleeved in the protection sleeve 3.

The junction box 1 refers to a device for protecting and managing an electrical connection. For example, the junction box 1 protects internal wires thereof from an intrusion of moisture, so as to avoid electrical accidents such as short circuits, leakages, etc. The junction box is suitable for various environments, e.g., a wet or dusty environment, etc. The junction box suitable for the wet or dusty environment is also called a waterproof junction box.

The connection tube 2 is used to connect the junction box 1 and the protection sleeve 3. One end of the connection tube 2 is connected to the junction box 1, and the other end of the connection tube 2 is connected to the protection sleeve 3. The connections between the connection tube 2 and the junction box 1 as well as between the connection tube 2 and the protection sleeve 3 adopt various manners, e.g., threaded connection, snapping connection, etc. FIG. 2 is a schematic diagram specifically illustrating a connection between the connection tube 2 and the protection sleeve 3. As shown in FIG. 2, the other end of the connection tube 2 is in a plug-in connection or a threaded connection with the protection sleeve 3.

The connection tube 2 is made of various materials, for example, metal, etc. The connection tube made of metal is referred to as a metal connection tube. The connection tube has various shapes, e.g., a straight tube, a reducer, etc., which is not limited here.

The protection sleeve 3 refers to a tubular material used to protect the thermocouple core.

The protection sleeve 3 is made of a precious metal such as platinum, gold, silver, palladium, etc., and the protection sleeve 3 is referred to as a precious metal protection sleeve, which has a high purity, a high density, and a high corrosion resistance. The protection sleeve made of the precious metal has a strong chemical stability and is able to be used in various corrosive environments.

In some embodiments, a material of the protection sleeve 3 includes PtRh10.

PtRh10 refers to a platinum-rhodium alloy, in which the rhodium (Rh) content is 10% and the platinum (Pt) content is 90%.

In some embodiments of the present disclosure, by using PtRh10 as the material for the protection sleeve, a high-temperature oxidation resistance of the PtRh10 is fully utilized to prevent the thermocouple core from corrosion and abrasion at a high temperature, which improves a protection for the thermocouple core.

In some embodiments, a diameter of the protection sleeve 3 is within a first preset range. The first preset range refers to a preset range of a preferred diameter for the protection sleeve 3, which is designed based on a structure of the thermocouple at the pool bottom. For example, the first preset range is designed based on a diameter of the thermocouple core. In some embodiments, the diameter of the protection sleeve 3 is in a range of 10 mm-15 mm. For example, the diameter of the protection sleeve 3 is 10 mm or 15 mm. As another example, the diameter of the protection sleeve 3 is 12 mm.

In some embodiments of the present disclosure, by reasonably setting the diameter of the protection sleeve, the connection with the connection tube is realized, and a sufficient space is provided for the thermocouple core and other materials inside the protection sleeve 3, so as to ensure a solid connection of the device.

In some embodiments, the insulating material 6 is disposed between the connection tube 2 and the protection sleeve 3. For example, at a plug end of the connection tube 2 and the protection sleeve 3, the insulating material 6 is disposed on a side where the two are abutted to enable insulation between the connection tube 2 and the protection sleeve 3.

The insulating material 6 is a material that prevents or restricts a flow of electric current, whose primary function is to isolate an electrical conductor to prevent an electric current leakage, a short circuit, and an electric shock.

The insulating material 6 is made of various materials, for example, polyvinyl chloride (PVC), polytetrafluoroethylene (PTFE), polyethylene (PE), etc.

In some embodiments, the insulating material uses high purity alumina. The high purity alumina is referred to as a high purity aluminum oxide.

In some embodiments, the insulating material 6 includes a high purity alumina with a purity greater than or equal to 99%.

In some embodiments, the high purity alumina has extremely low impurity content, e.g., the alumina with a purity of 99.5% is adopted.

In some embodiments of the present disclosure, by setting the purity of the high purity alumina, a content of impurities in the alumina is effectively reduced to ensure physical and chemical properties of the alumina.

In some embodiments of the present disclosure, by using the high purity alumina as the insulating material, excellent electrical insulating property, stability, corrosion resistance, and thermal conductivity, etc. of the high purity alumina are fully utilized, which not only improves temperature measuring reliability and accuracy, but also extends an overall service life of the thermocouple.

In some embodiments, a room temperature insulation resistance of the insulating material 6 is not less than 1000Ω. For example, the room temperature insulation resistance of the insulating material 6 is 1014Ω, etc.

The room temperature insulation resistance refers to a resistance between electrically insulating materials or devices measured at standard ambient temperatures (usually 20° C. or 25° C.). The room temperature insulation resistance is used to evaluate the insulating property of an electrical device, a material, or a system, i.e., an ability to resist a passage of the electric current under non-conductive conditions.

In some embodiments of the present disclosure, by setting a minimum requirement of the room temperature insulation resistance, accidents such as leakage and short-circuit are prevented to ensure a safety of an operator; and a proper insulation resistance protects the device from damage caused by electrical stresses and reduces premature aging and wear, thereby extending the service life of the device.

In some embodiments, when the connection tube 2 is connected to the protection sleeve 3, a connected inner cavity is formed inside the protection sleeve 3 and the connection tube 2, and the connected inner cavity is used to install the protection tube 7 for protecting the thermocouple core 5.

The protection tube 7 is a tubular structure for mounting and protecting the thermocouple core 5. In some embodiments, the protection tube 7 is made of a material that is resistant to heat, corrosion, and abrasion. For example, the protection tube 7 is made of a corundum material. The protection tube 7 made of the corundum material is referred to as a corundum protection tube.

In this embodiment, the protection tube 7 is used as the protection tube for thermocouple cores 5 in a high temperature furnace to prevent corrosion and abrasion of the thermocouple cores 5 at the high temperature. The corundum protection tube is high temperature resistant and can be used for a long period of time at a high temperature of up to 1,800° C. The corundum protection tube also has a good corrosion resistance, which is able to resist the erosion of various chemicals.

As shown in FIG. 1 and FIG. 2, the thermocouple core 5 is embedded in an inner cavity of the protection tube 7, and the protection tube 7 is mounted in the connected inner cavity formed by connecting the connection tube 2 to the protection sleeve 3. One end of the protection tube 7 is disposed in the connection tube 2, and the other end of the protection tube 7 is disposed in the protection sleeve 3.

In some embodiments, the gap sealing material 4 is sealingly filled between the protection sleeve 3 and the thermocouple core 5. For example, the gap sealing material 4 is filled between the protection sleeve 3 and the protection tube 7 mounted with the thermocouple core. In some embodiments, as shown in FIG. 3, there is a gap between the thermocouple core 5 and the protection tube 7, and the gap is sealingly filled with the gap sealing material 4.

The gap sealing material 4 refers to a material used to fill a gap between the protection tube 3 and the thermocouple core 5. The gap sealing material includes one or more materials, for example, one or more of a silicone sealant, an epoxy sealant, etc.

In some embodiments, the gap sealing material includes a high purity alumina slurry.

The high purity alumina slurry refers to a fluid suspension containing high purity alumina particles. The high purity alumina slurry typically consists of a combination of fine alumina powder and a suitable carrier liquid, and also contains dispersant and other additives to enhance a performance and a stability of the high purity alumina slurry.

In some embodiments, the high purity alumina slurry includes high purity alumina and a rheological agent.

In some embodiments, a purity of the high purity alumina in the high purity alumina slurry is greater than or equal to 99%. For example, the purity of the high purity alumina is 99.5%, etc.

In some embodiments of the present disclosure, by using the high purity alumina with a purity greater than or equal to 99%, characteristics of high temperature resistance and electrical insulation of the high purity alumina are fully utilized to make the prepared device effective in preventing the thermocouple at the pool bottom from oxidation and volatilization. An application of the high purity alumina not only improves the reliability and accuracy of temperature measurement, but also extends the overall life of the thermocouple, while reducing maintenance costs.

The rheological agent is an additive used to modulate the rheological property (i.e., flow and deformation behaviors) of a slurry. For example, the rheological agent includes one or more of a thickener, the dispersant, a wetting agent, and a binder.

In some embodiments, a material of the rheological agent in the high purity alumina slurry includes carboxymethyl Cellulose.

The carboxymethyl cellulose (CMC) is a derivative of a cellulose.

In some embodiments of the present disclosure, the CMC is used as the rheological agent, which makes full use of the stability of CMC, and is conducive to a stabilization of the high purity alumina slurry.

In some embodiments, an amount of rheological agent added is within a second preset range by weight, and a sedimentation volume of the suspension in the high purity alumina slurry is within a third preset range. The second preset range and the third preset range are preset according to actual needs.

In some embodiments, the amount of the rheological agent added is in a range of 1.0 wt %-1.2 wt %, and the sedimentation volume of the suspension in the high purity alumina slurry is in a range of 9%-11%. For example, the amount of the rheological agent added is 1.0 wt % and the sedimentation volume of the suspension in the high purity alumina slurry is 9%. As another example, the amount of the rheological agent added is 1.2 wt % and the sedimentation volume of the suspension in the high purity alumina slurry is 11%. As another example, the amount of the rheological agent added is 1 wt % and the sedimentation volume of the suspension in the high purity alumina slurry is 11%. As a further example, the amount of the rheological agent added is 1.2 wt % and the sedimentation volume of the suspension in the high purity alumina slurry is 9%.

The sedimentation volume of the suspension refers to a volume occupied by solid particles in the suspension that sink to the bottom under gravity or a centrifugal force after a certain period of time. The sedimentation volume of the suspension is usually associated with a total volume of an initial suspension, and is used to indicate a degree of concentration of the solid particles after sedimentation.

In some embodiments of the present disclosure, through a great count of experiments, on a premise of ensuring a fluidity, a molding speed, and a later structural strength of the high purity alumina slurry, an additional amount of the rheological agent is 1.0 wt % to 1.2 wt %. At this time, the sedimentation volume of the suspension in the high purity alumina slurry is 9%˜11%, and the high purity alumina slurry has good physical properties.

In some embodiments of the present disclosure, in a suspension containing high purity alumina particles, the rheological agent helps maintain a suspension state of these particles, prevents sedimentation, and ensures homogeneity of the material; and the rheological agent is used to adjust viscosity and flow characteristics of an alumina containing product, making the alumina containing product easier to be processed and controlled in an application process. At the same time, a high melting point of the high purity alumina makes the high purity alumina suitable for the high temperature environment of the glass furnace.

In some embodiments of the present disclosure, the use of the high purity alumina slurry facilitates an injection of the gap sealing material into the protection sleeve; and the high purity alumina slurry ensures a uniform distribution of the alumina particles, which improves mechanical and chemical properties of a final product. The coating formed by the high purity alumina slurry provides an excellent insulating property and prevents the thermocouple core from reacting with the protection sleeve. The high purity alumina slurry provides a dense and smooth surface, which contributes to a resistance to oxidation of the material. The structure formed by the high purity alumina slurry is suitable for the high temperature environment in which the glass furnace is located.

The thermocouple core 5 is a portion of the thermocouple. The thermocouple is a sensor used for the temperature measurement. The thermocouple core consists of two different conductors or semiconductor materials that are connected to each other at one end point to form a measurement junction (referred to as a thermal junction). When a temperature of the measurement junction is different from a reference junction at the other end (which is usually kept at a known reference temperature), a potential difference is generated between the two materials, based on which the temperature measurement is realized.

As the core portion of the thermocouple, the thermocouple core 5 is composed of thin wires of two different metallic materials. The metal wires are connected to each other at the end to form the thermal junction. The two different metallic materials include, for example, iron-constantan, copper-constantan, nickel-chromium-nickel-silicon, etc.

In some embodiments, the thermocouple core 5 includes a B-type thermocouple or an R-type thermocouple.

The B-type thermocouple refers to a high temperature thermocouple composed of two platinum-rhodium alloys.

The R-type thermocouple refers to a high temperature thermocouple composed of platinum and a platinum-rhodium alloy.

In some embodiments, the B-type thermocouple has a positive pole made of PtRh30 and a negative pole made of PtRh6, and the R-type thermocouple has a positive pole made of PtRh13 and a negative pole made of Pt.

PtRh30, PtRh6, and PtRh13 are platinum-rhodium alloys. The content of Rh in PtRh30 is 30%, and the content of Pt in PtRh30 is 70%. The content of Rh in PtRh6 is 6%, and the content of Pt in PtRh6 is 94%. The content of Rh in PtRh13 is 13%, and the content of Pt in PtRh13 is 87%.

The B-type thermocouple, also referred to as a B-type thermocouple wire, uses 70% platinum and 30% rhodium as the conductor material. This thermocouple has an excellent performance in a measurement range of very high temperatures (e.g., 800° C. to 1800° C.). The B-type thermocouple has good physical and chemical properties, a good thermoelectric potential stability, and a good oxidation resistance at high temperatures, and is suitable for use in oxidizing and inert atmospheres.

The R-type thermocouple, also referred to as a single platinum-rhodium thermocouple, includes a conductor containing 87% platinum, 13% rhodium, and a conductor contains 100% pure platinum. This thermocouple is suitable for temperatures up to 1,600° C., and has advantages of the highest accuracy, the best stability, a wide temperature measurement range, a long service life, etc. The R-type thermocouple has good physical and chemical properties, good thermal potential stability and oxidation resistance at high temperatures, and is suitable for use in oxidizing and inert atmospheres.

Those skilled in the art can select the B-type thermocouple or the R-type thermocouple according to actual production needs.

In some embodiments of the present disclosure, by setting the materials used for the positive and negative electrodes of each of the B-type thermocouple and the R-type thermocouple, the thermocouple core can be made suitable for use in the high temperature environment of the glass furnace.

In some embodiments, a filament diameter of the thermocouple core 5 is within a fourth preset range. The fourth preset range is preset according to actual needs. The filament diameter is a diameter of the metal wire that forms the thermocouple.

In some embodiments, the filament diameter of the thermocouple core 5 is 0.5 mm-1 mm. For example, the filament diameter of the thermocouple core 5 is 0.5 mm. As another example, the filament diameter of the thermocouple core 5 is 0.8 mm. As another example, the filament diameter of the thermocouple core 5 is 1 mm.

In some embodiments of the present disclosure, by reasonably setting the filament diameter of the thermocouple core, a mechanical strength and a high temperature resistance of the thermocouple are effectively improved, so as to make it suitable for an environment where the temperature fluctuates violently.

In some embodiments of the present disclosure, by using the B-type thermocouple or the R-type thermocouple, the stability and durability thereof in the high temperature environment are fully utilized to make the thermocouple cores ultimately obtained suitable for the high temperature environment of the glass furnace. At the same time, using the R-type thermocouple also improves the accuracy of temperature measurement.

The device for preventing the oxidation and volatilization of the thermocouple at the bottom of the pool is typically used in the high temperature environment to protect the performance of thermocouple and to extend the service life of the thermocouple. The high temperature environment exists in several scenarios, such as metal smelting and processing, ceramic manufacturing, a petrochemical industry, a cement industry, an aerospace industry, etc. The device for protecting the thermocouple obtained by selecting suitable materials and designs is also used in other scenarios, which is not limited here.

During the manufacturing process described above, it is necessary to ensure that the sealing of the protection sleeve is air tightened to prevent an entry of oxidizing gases and other contaminants. The manufactured device is mounted at an appropriate position within the glass furnace to ensure an accurate temperature measurement. Furthermore, the device should not be placed in a region that is in direct contact with a molten glass to minimize a mechanical damage or avoid overheating. During use, periodical checks of tear situation of the protection sleeve and the thermocouple are performed, so as to ensure that there is no physical damage or sealing failure; a carbon deposition or other deposits on an outside surface of the device are cleaned to ensure a proper function of the device; a periodical calibration is performed on the thermocouple to ensure that an output of the thermocouple is accurate; and temperature are read from a measurement and control system associated with the device to ensure a timely response to prevent damage to the device due to an over-temperature.

In some embodiments of the present disclosure, by setting the insulating material and the high purity alumina slurry at two ends of the thermocouple core, respectively, high temperature oxygen is prevented from entering and causing oxidation and volatilization of the filament diameter and the sleeve that affects a measurement accuracy of the thermocouple. By setting a relative position, a material, and a size of each component of the device, the prepared device is able to accurately monitor temperature changes in the glass furnace, and reduce the oxidation and volatilization at the pool bottom, which makes the furnace continue to operate efficiently and stably for a long time during the operation cycle, and provides direction and basis for the optimization and the adjustment of the process.

Finally, it should be noted that the above embodiments are only used to illustrate the technical solutions of the present disclosure, and are not intended to be a limitation of the technical solutions of the present disclosure; notwithstanding that the present disclosure has been described in detail with reference to the foregoing embodiments, it should be understood by those skilled in the art that they are still able to make modifications to the technical solutions documented in the foregoing embodiments, or replace some or all of the technical features with equivalent ones; and these modifications or replacements do not take the essence of the corresponding technical solutions out of the scope of the technical solutions of the embodiments of the present disclosure.

What is claimed is:

1. A device for preventing an oxidation and volatilization of a thermocouple at a pool bottom, including a junction box, a connection tube, a protection sleeve, a thermocouple core, and a protection tube, wherein
an insulating material is disposed between the connection tube and the protection sleeve,
a gap sealing material is sealingly filled between the protection tube and the thermocouple core, and
one end of the protection tube is sleeved in the connection tube, and the other end of the protection tube is sleeved in the protection sleeve.

2. The device of claim 1, wherein the insulating material includes high purity alumina.

3. The device of claim 2, wherein a purity of the high purity alumina is greater than or equal to 99%.

4. The device of claim 1, wherein a room temperature insulation resistance of the insulating material is not less than 1000Ω.

5. The device of claim 1, wherein a material of the protection sleeve includes PtRh10.

6. The device of claim 1, wherein a diameter of the protection tube is 10 mm-15 mm.

7. The device of claim 1, wherein the thermocouple core is a B-type thermocouple or an R-type thermocouple.

8. The device of claim 7, wherein
a material of a positive pole of the B-type thermocouple is PtRh30, and a material of a negative pole of the B-type thermocouple is PtRh6; and
a material of a positive pole of the R-type thermocouple is PtRh13, and material of a negative pole of the R-type thermocouple is Pt.

9. The device of claim 7, wherein a filament diameter of the thermocouple core is in a range of 0.5 mm-1 mm.

10. The device of claim 1, wherein the gap sealing material includes a high purity alumina slurry.

11. The device of claim 9, wherein the high purity alumina slurry includes high purity alumina and a rheological agent.

12. The device of claim 10, wherein a purity of the high purity alumina in the high purity alumina slurry is greater than or equal to 99%.

13. The device of claim 10, wherein a material of the rheological agent in the high purity alumina slurry includes carboxymethyl cellulose.

14. The device of claim 10, wherein an amount of the rheological agent added is 1.0 wt %-1.2 wt %, and a sedimentation volume of a suspension in the high purity alumina slurry is 9%-11%.
